(19) United States
(12) Patent Application Publication
(10) Pub. No.: US 2026/0296713 A1
(43) Pub. Date: Oct. 1, 2026

(54) FIBRE BASED PACKAGING CONTAINER, CIRCULAR BASE COMPONENT, QUADRILATERAL WALL BLANK, METHOD OF MANUFACTURE OF A FIBRE BASED PACKAGING CONTAINER AND CONTAINER OBTAINABLE FROM SAID METHOD

(71) Applicant: TRANSCEND PACKAGING LIMITED, Hengoed, Wales (GB)

(72) Inventor: Lorenzo ANGELUCCI, Hengoed (GB)

(21) Appl. No.: 19/477,699

(22) PCT Filed: Sep. 20, 2024
(86) PCT No.: PCT/EP2024/076545

§ 371 Date: Oct. 22, 2025

(30) Foreign Application Priority Data
Sep. 20, 2023 (GB) 2314423.1
Jan. 19, 2024 (GB) 2400757.7
May 17, 2024 (GB) 2407027.8

(51) Int. Cl. B65D 3/14; B31B 50/26; B31B 50/64; B31B 105/00; B31B 110/10; B65D 3/06; B65D 3/28

(52) U.S. Cl. CPC B65D 3/14; B31B 50/26; B31B 50/64; B65D 3/06; B65D 3/28; B31B 2105/00; B31B 2110/10

(57) ABSTRACT

The present invention provides a fibre based packaging container for holding liquids, the packaging container comprising: a tubular wall component having an inner wall surface and an outer wall surface opposing the inner wall surface, the inner wall surface provided with a liquid impermeable layer and having a base sealing portion at one end of the tubular wall component; and a circular base component having an outer edge, an inner base surface and an outer base surface opposing the inner base surface, the inner base surface provided with a liquid impermeable layer and having: a circumferential region of the inner base surface, the circumferential region having a sealable lacquer coating, a fold line extending circumferentially around the inner base surface within the circumferential region of the inner base surface, and a wall sealing portion located on the inner base surface between the outer edge of the base and the fold line, wherein the wall sealing portion is folded at 80 to 100 degrees about the fold line to form a folded portion, wherein the folded portion and at least a portion of the base sealing portion are sealed to one another to form a base seam and provide a three dimensional container form, such that the sealable lacquer coating is present within the base seam between the wall and base components.

The present invention relates general to paperboard containers, such as a disposable cups, components thereof and methods of forming the same. More specifically, the present invention relates to containers such as beverage cups formed from paperboard with a liquid impermeable layer and sealable lacquer coating within the base seam as well as bases and walls that may be used to produce such cups.

### BACKGROUND OF THE INVENTION

Originally, disposable beverage cups and drinking containers typically were formed of fibre based board comprising a layer of polyethylene or other polymeric material to provide a liquid barrier. However, more recently, the use of polyethylene and certain other polymers has been banned in many countries as the environmental impact of polymeric waste is of serious concern. Therefore, there has been a significant move in the disposable packaging industry towards manufacture using alternative, more environmentally acceptable materials. In particular, the manufacture of disposable cups and drinking containers using fibre based materials coated with materials other than polyethylene to provide a water impermeable layer is known.

During manufacture of such containers, a thin barrier layer is applied to a surface of the fibre based material before the coated material is spooled into reels. Such barrier coatings may be organic (for example, polymers or monomers other than those identified as being of environmental concern e.g. polyethylene) or inorganic (for example, comprising mineral materials) or a mix of both. The reels are printed to apply any required outer decoration and then carefully machine cut into accurately measured cup sidewall blanks. The blanks are inserted into cup forming machines that wrap the sidewall blanks into a cup shape and seal them, and the cup bottom is subsequently added and heat sealed in place. The seams of the cups are sealed to make the cups liquid proof. In some cases, folding or crimping of the seam between the wall and base takes place to further strengthen the form of the cup. In addition, the upper edge of the wall is often rolled to provide a more comfortable rim for the user when drinking from the cup.

Such processes are based on and largely replicate processes for manufacturing cups having polyethylene barrier coatings applied thereto. However, many of the more environmentally friendly liquid barrier materials have a lower degree of elasticity than polyethylene. Accordingly, when substrates coated with these alternative barriers are subjected to manufacturing processes developed for polyethylene coated substrates, the different tolerances of the materials can cause issues, for example cracking of the coating when the coated substrate is folded or curled, thus reducing liquid barrier function. Additionally, flexing of the cup which results from filling of the cup with liquid and subsequent manipulation of the cup by the user, may result in cracks in the coating located within the seams, thus leading to absorption of liquid into the wall of the cup causing it to become saturated and prone to leakage, or even the total failure of the seam.

There is therefore a need for an improved container design that is suitable for use with less elastic liquid barrier coatings to avoid the aforementioned loss in liquid barrier function and potential seam failure.

### SUMMARY OF THE INVENTION

The present invention seeks to address the problems of the prior art.

Aspects of the present invention are set out in the attached claims.

According to an aspect of the present invention, there is provided a fibre based packaging container for holding liquids, the packaging container comprising:
a. a tubular wall component comprising an inner wall surface and an outer wall surface opposing the inner wall surface, the inner wall surface comprising a liquid impermeable layer and a base sealing portion at one end of the tubular wall component; and
b. a circular base component comprising an outer edge, an inner base surface and an outer base surface opposing the inner base surface, the inner base surface comprising a liquid impermeable layer and further comprising: a circumferential region comprising a sealable lacquer coating, a fold line extending circumferentially around the inner base surface within the circumferential region of the inner base surface, and a wall sealing portion located on the inner base surface between the outer edge of the circular base component and the fold line, wherein the circular base component is folded at 80 to 100 degrees about the fold line to form a folded portion comprising the wall sealing portion,
wherein the wall sealing portion and at least a portion of the base sealing portion are sealed to one another to form a base seam and provide a three dimensional container form, such that the sealable lacquer coating is present within the base seam.

As the circumferential region of the inner base surface, which comprises the sealable lacquer coating, extends beyond the fold line in a direction away from the outer edge of the base, a portion of the sealable lacquer coating extends across and beyond the fold line. Advantageously, the inventors have identified that by providing the sealable lacquer coating across and beyond the fold line, the sealable lacquer coating, which is of a more elastic nature than the liquid impermeable layer, minimises cracking of the liquid impermeable layer, which is less elastic, on the inner base surface at the fold line. This strengthens the container at the fold line and also prevents seepage of liquid into the wall and leakage of liquid from the container during use.

In one embodiment, the base sealing portion of the tubular wall component also comprises a sealable lacquer coating. This provides an additional layer of sealable lacquer coating between the tubular wall and the circular base component.

The inner wall surface and/or the inner base surface may comprise a liquid impermeable layer on the entirety or at least substantially all of the entirety of that surface/those surfaces.

Examples of liquid impermeable layer materials and details regarding their properties will now be discussed. These exemplary materials and properties may be comprised in the liquid impermeable layer comprised on the inner wall surface, the inner base surface and/or one or more of the second, third and/or fourth edges of the quadrilateral blank, the second liquid impermeable layer applied to the rolled rim, the further liquid impermeable layer applied to the inner wall surface and/or the inner base surface, or any other liquid impermeable layer applied to any part of the container obtainable from the process of the present invention.

The liquid impermeable layer comprised on the inner wall surface and/or the inner base surface may be polymeric and/or monomeric. In certain embodiments, the polymer and/or monomer is of natural origin, i.e. the polymer and/or monomer is produced by organisms (e.g. microorganisms, plants or animals) which are optionally not genetically modified. For example, the liquid impermeable layer may comprise micro or nano cellulose, polyhydroxybutyrate (PHB), polyhydroxyalkanoate (PHA), vegetable origin protein, vegetable origin polysaccharide, fatty acid such as stearic acid or mixtures thereof. In embodiments of the invention, the liquid impermeable layer does not comprise polyethylene.

Additionally or alternatively, the liquid impermeable layer comprised on the inner wall surface and/or the inner base surface may be inorganic, for example it may be a mineral liquid impermeable layer, e.g. it may comprise mineral materials such as silica, silica-based materials (e.g. ceramic), alkoxysilane, calcium carbonate, and/or kaolin. In embodiments the mineral material is provided in particulate form in an aqueous and/or alcohol solution which may be in the form of a gel (e.g. a sol-gel) which is then applied to the inner wall surface and/or the inner base surface. Examples of materials which may be used to provide mineral liquid impermeable layers include those listed in International Patent Publication Nos. WO2022/171893, WO2023/285499, WO2022/112566 and WO2021/019220.

In preferred embodiments of the invention, the liquid impermeable layer comprised on the inner wall surface and/or the inner base surface is biodegradable. In some embodiments, the liquid impermeable layer comprised on the inner wall surface and/or the inner base surface comprises a monomer and/or a polymer which is biodegradable.

The liquid impermeable layer comprised on the inner wall surface and/or the inner base surface may be metallic, e.g. it may contain metallic particles or a metallic film. However, given that the inclusion of metals will adversely affect the recyclability of the container to which it is applied as well as requiring the use of mined metals which adds to the carbon footprint of the container, the use of metals in the liquid impermeable layer is preferably avoided. Accordingly, in some embodiments, the liquid impermeable layer and/or the sealable lacquer coating comprised on the inner wall surface is free of metallic film. In embodiments, the liquid impermeable layer and/or the sealable lacquer coating comprised on the inner wall surface is free of metallic particles. In some embodiments, the liquid impermeable layer and/or the sealable lacquer coating comprised on the inner base surface is free of metallic film. In certain embodiments, the liquid impermeable layer and/or the sealable lacquer coating comprised on the inner base surface is free of metallic particles.

In preferred embodiments of the invention, the liquid impermeable layer comprised on the inner wall surface and/or the inner base surface is recyclable. In some embodiments, the liquid impermeable layer comprised on the inner wall surface and/or the inner base surface comprises a monomer and/or a polymer which is recyclable.

The liquid impermeable layer comprised on the inner wall surface and/or the inner base surface may be less elastic than polyethylene. LDPE (low density polyethylene), which has conventionally been used to provide a liquid impermeable layer to fibre based containers such as paper cups has a modulus of elasticity of 0.13 to 0.30 GPa. Thus, in embodiments of the invention, the liquid impermeable layer comprised on the inner wall surface and/or the inner base surface may have a modulus of elasticity equal to or greater than about 0.3 GPa, equal to or greater than about 0.5 GPa, equal to or greater than about 1 GPa, equal to or greater than about 5 GPa or equal to or greater than about 10 GPa. In some embodiments, the modulus of elasticity of the liquid impermeable layer comprised on the inner wall surface and/or the inner base surface may have a modulus of elasticity of about 1 GPa to about 1000 GPa, about 5 GPa to about 500 GPa or about 10 to about 100 GPa.

Where reference is made to quantified modulus of elasticity values herein, these are calculated in accordance with ASTM D638-Standard Test Method for Tensile Properties of Plastics.

In embodiments, the liquid impermeable layer comprised on the inner wall surface and the inner base surface is the same. In alternative embodiments, the liquid impermeable layer comprised on the inner wall surface and the inner base surface is different. As discussed below, whether the liquid impermeable layer comprised on the inner wall surface and the inner base surface is the same or different, a sealable lacquer coating may be comprised on the sealing portions of those surfaces.

The liquid impermeable layer comprised on the inner wall surface and/or the inner base surface may have any thickness provided that it provides effective liquid barrier properties. The effective thickness of the layer will depend, to a certain extent, on the material used to form the layer. However, in embodiments of the invention, the thickness of the liquid impermeable layer comprised on the inner wall surface and/or the inner base surface may be from about 1 to about 100 μm, about 5 to about 50 μm, about 10 to about 25 μm or about 12 to 20 μm.

Additionally or alternatively, the liquid impermeable layer may have a weight of from about 1 to about 20 g/m², about 2 to about 12 g/m² or about 3 to about 8 g/m².

In some embodiments, the weight/thickness of the liquid impermeable layer applied to the inner wall surface may be greater than that applied to the inner base surface. In certain embodiments, the weight/thickness of the liquid impermeable layer applied to the inner base surface may be greater than that applied to the inner wall surface. In other embodiments, the weight/thickness of the liquid impermeable layer applied to the inner wall surface may be the same as that applied to the inner base surface.

The liquid impermeable layer may be applied in liquid form (e.g. in the aqueous form and/or in the form of a solution or an emulsion) and then dry (air-dried, via the application of heat, or the like) to provide the liquid impermeable barrier. In such embodiments, the liquid impermeable barrier may be applied to the inner wall surface and/or the inner base surface using any technique known to those skilled in the art, for example, by printing, brushing, spraying or the like.

As explained herein, the function of the liquid impermeable layer is to provide a barrier to moisture and liquid passing into the cup wall or base, which can result in saturation of the wall and/or base paper fibres and leakage of the liquid therefrom. In embodiments, the liquid impermeable layer comprised on the inner wall surface and/or the inner base surface may provide the wall and/or base, respectively, with a Cobb₆₀ value of less than about 10 g/m², less than about 5 g/m², less than about 2 g/m², less than about 1 g/m ², or about 0 g/m² . Cobb₆₀ values are measured in accordance with ISO standard 535 (Paper and Board).

In a further embodiment, the liquid impermeable layer comprises an inorganic mineral.

The outer wall surface and/or outer base surface may or may not comprise a liquid impermeable layer.

In embodiments, the outer wall surface and/or outer base surface may comprise a varnish (for example an overall protective varnish). This may be the same material or different to the sealable lacquer employed in aspects of the present invention.

In certain embodiments of the invention, the sealable lacquer coating is provided on top of the liquid impermeable layer, for example on the wall sealing portion, on the base sealing portion, on the first edge sealing portion and/or the second edge sealing portion.

In some embodiments, the base sealing portion of the wall component may also comprise a sealable lacquer coating to further strengthen sealing of the circular base component to the wall component. In such embodiments, the sealable lacquer coating may be provided on top of the liquid impermeable layer.

The inventors have advantageously found that the provision of sealable lacquer coatings on both surfaces of the circular base component contributes strongly to the prevention of liquid ingress into the circular base component. Accordingly, in some embodiments, the outer base surface of the circular base component comprises a second wall sealing portion having a sealable lacquer coating. The second wall sealing portion may be located circumferentially around the edge of the outer base surface of the circular base component. In such embodiments, the outer base surface of the circular base component may comprise a fold line corresponding to the fold line provided on the inner base surface of the circular base component and the second wall sealing portion may be located on the outer base surface between the fold line and the outer edge of the circular base component. In such embodiments, the base sealing portion of the wall component may be sealed to both the wall sealing portion and the second wall sealing portion, e.g. by being folded around the outer edge of the circular base component.

Any type of food approved sealable lacquer coating may be employed in the present invention provided that it is capable of providing a liquid resistant seal upon activation. In some embodiments, the lacquer coating may be heat sealable (e.g. at a temperature of around 100° C. to about 250° C.), for example it may be sealable via contact with hot pressured air. Additionally or alternatively, the lacquer coating may be ultrasonically sealable (e.g. at a frequency of around 20 mHz to about 40 mHz). Other types of sealable lacquer coating could also be employed, e.g. pressure sealable lacquer coatings.

In certain embodiments, the sealable lacquer coating and/or the liquid impermeable layer may be free of fluorinated compounds. In some embodiments, the sealable lacquer coating and/or the liquid impermeable layer may be free of poly-and perfluoroalkyl substances (PFAS), for example perfluorooctane sulfonate (PFOS) and perfluorooctanoic acid (PFOA).

In embodiments of the invention, the sealable lacquer coating materials that may be employed are those which are environmentally friendly, for example which are biodegradable. Advantageously, unlike conventional fibre based containers comprising polyethylene based liquid impermeable layers, this permits containers to be composted at home or industrially following disposal of the container. Specific lacquer coating materials which may be utilised include polyolefin, polyurethane, polyvinyl (e.g. polyvinylacetate), polyester and/or acrylic lacquers. The lacquers may be provided in the form of solutions, e.g. aqueous solutions, which are then applied to the wall component and/or the base component at the desired location/s. The sealable lacquer coating may be applied at a coating weight of about 1 to about 50 g/m2 , about 3 to about 30 g/m², about 5 to about 25 g/m² , about 6 to about 22 g/m² about 8 to about 20 g/m² or about 10 to about 15 g/m².

In embodiments in which the base sealing portion and the wall sealing portion both are provided with sealable lacquer, the weight of the sealable lacquer provided in the wall sealing portion may be greater than the weight of the sealable lacquer provided in the base sealing portion. For example, the weight of the sealable lacquer provided in the wall sealing portion may be about 5 to about 20 g/m², about 6 to about 15 g/m² or about 10 to about 15 g/m² . Additionally or alternatively, the weight of the sealable lacquer provided in the base sealing portion may be about 3 to about 15 g/m² , about 5 to about 10 g/m² or about 6 to about 8 g/m² .

In certain embodiments, the thickness of the sealable lacquer coating applied to the inner base surface is consistent. For example, the thinnest part of the sealable lacquer coating applied to the inner base is no less than about 20%, no less than about 30%, no less than about 40%, no less than about 50%, no less than about 60%, no less than about 70% or no less than about 80% of the thickness of the thickest part of the sealable lacquer coating applied to the inner base surface.

The sealable lacquer coating preferably is elastic. In preferred embodiments, the sealable lacquer coating is more elastic than the liquid impermeable layer, i.e. it has a lower modulus of elasticity than the liquid impermeable layer. For example, the sealable lacquer coating may have a modulus of elasticity of less than about 5 GPa, less than about 2 GPa, less than about 1 GPa, less than about 0.5 GPa, less than about 0.2 GPa or less than about 0.1 GPa. In some embodiments, the sealable lacquer coating has a modulus of elasticity of about 0.01 GPa to about 1 GPa, about 0.012 GPa to about 0.5 GPa or about 0.015 to about 0.1 GPa.

Where reference is made herein to the sealable lacquer coating being comprised on or in a region or portion of a component, the sealable lacquer coating may be comprised on the entirety of that region or portion a substantial part thereof.

In embodiments of the invention, in the container of the present invention, the circumferential region provided on the inner base surface of the circular base component comprises a sealable lacquer coating and this extends from the outer edge of the circular base component and beyond the fold line. Thus, in the assembled container, a portion of the circumferential region comprising sealable lacquer coating extends across the inner surface of the circular base component and beyond the base seam in a direction away from the adjacent tubular wall component. Preferably, the sealable lacquer coating extends at least 2 mm beyond the base seam. In certain embodiments, the sealable lacquer coating extends at least 4 mm beyond the base seam. In some embodiments, the sealable lacquer coating extends at least 6 mm beyond the base seam. Additionally or alternatively, the sealable lacquer coating extends less than 15 mm beyond the base seam. In embodiments, the sealable lacquer coating extends less than 10 mm beyond the base seam. In some embodiments, the sealable lacquer coating extends less than 8 mm beyond the base seam. In certain embodiments, the sealable lacquer coating extends less than 6 mm beyond the base seam.

In embodiments, the sealable lacquer coating extends about 1 mm to about 10 mm or about 2 mm to about 6 mm beyond the base seam. However, it is to be appreciated that having the sealable lacquer coating extend any distance beyond the base seam means that the sealable lacquer coating is extending over the fold line. Thus, the sealable lacquer coating protects the base seam from failing due to cracking of the liquid impermeable layer and/or seam during filling or flexing of the container, particularly in view of the less elastic nature of the liquid impermeable layer.

In embodiments, the entirety of the inner base surface does not comprise the sealable lacquer coating, i.e. the inner base surface comprises a central portion which does not comprise sealable lacquer coating.

In some embodiments, the inner base surface may comprise a second liquid impermeable layer covering the sealable lacquer coating which extends beyond the base seam and optionally the first liquid impermeable layer.

The second liquid impermeable layer may comprise the same barrier material as the first liquid impermeable layer applied to the inner base surface of the base.

In alternative embodiments, the second liquid impermeable layer may comprise a different barrier material as the liquid impermeable layer applied to the inner base surface of the base.

The second liquid impermeable layer may comprise any of the liquid impermeable barrier materials and/or have any of the properties of the liquid barrier materials discussed herein.

The wall component and/or the circular base component of the fibre based packaging container may comprise any suitable fibre based substrate, but preferably comprise a paperboard substrate, such as, but not limited to, cupstock and the like. In embodiments of the invention, the material from which the wall component and the base component are formed may be the same or different.

In some embodiments, the fibre based substrate is clay-coated, optionally on the inner wall surface.

The wall component and the circular base component may have any thickness which provides sufficient structural strength to the assembled container. In embodiments, the wall component and/or the circular base component may have a thickness (excluding the impermeable liquid layer and any sealable lacquer coating) of about 200 μm to about 2000 μm, about 250 μm to about 1000 μm, about 300 μm to about 500 μm or about 350 μm to about 500 μm.

Additionally or alternatively, the wall component and/or the circular base component may be formed from fibre based substrate having a weight of about 150 to about 500 g/m² , about 180 to about 350 g/m² , about 200 to about 330 g/m² or about 250 to about 300 g/m². In embodiments the circular base component is formed from fibre based substrate having a weight greater than 250 g/m² , greater than 255 g/m² or greater than 260 g/m².

In some embodiments, the fibre based substrate comprised in the wall component has a heavier weight than the fibre based substrate comprised in the circular base component. In certain embodiments, the fibre based substrate comprised in the circular base component has a heavier weight than the fibre based substrate comprised in the wall component. In other embodiments, the fibre based substrate comprised in the wall component has the same weight as the fibre based substrate comprised in the circular base component.

In embodiments of the invention, the circular base component is substantially planar, save for the folded portion which is folded at an angle from the remainder of the circular base component. The circular base component may have a diameter of from about 30 mm to about 100 mm, about 35 mm to about 80 mm, or about 40 mm to about 65 mm.

In some embodiments, the end of the tubular wall component opposite to that comprising the base seal may be rolled, e.g. to provide a more comfortable rim for the user when drinking from the cup.

In embodiments of the invention, a portion of the inner wall surface or the outer wall surface extending partially along that surface from the fourth edge of the quadrilateral blank/the upper edge of the tubular wall component may comprise an additional layer of liquid impermeable barrier material and/or sealable lacquer. In some embodiments, the portion comprises a sealable lacquer layer and an additional layer of liquid impermeable barrier material applied thereupon. This portion may extend from some or substantially all of the fourth edge. In embodiments, this portion extends from the entirety of the fourth edge.

The provision of such a portion extending from the fourth edge of the quadrilateral blank/the upper edge of the tubular wall component has been found by the inventors to advantageously improve the resistance of the container to moisture ingress, particularly from steam if the container of the invention comprises a hot beverage. The inclusion of this portion may also be advantageous for containers where a foil or membrane is sealed over the rim over the container.

As those skilled in the art will recognise, the tubular wall component may be perfectly cylindrical. In other embodiments, the tubular wall component may not be perfectly cylindrical. For example, it may be tapered, e.g. in the form of a truncated cone and/or such that the diameter of the tubular wall component at the end at which the base seal is formed is smaller than the diameter of the tubular wall component at its opposite end.

In the assembled container of the present invention, the wall sealing portion is folded about the fold line generally perpendicularly to the plane of the circular base component, towards the outer surface and away from the inner surface. By “generally perpendicularly” it is meant that the wall sealing portion is folded about the fold line by about 80° to about 100°, about 85° to about 95°, or about 90° from the plane of the circular base component.

The fold line may or may not be marked and/or visible prior to folding of the wall sealing portion. In some embodiments, the fold line may be scored or marked to facilitate reliable and repeatable positioning of the fold.

By configuring the circular base component as explained herein, this advantageously permits the production of containers having liquid impermeable layers formed of materials which have low elasticity. Thus, according to a further aspect of the present invention, there is provided a circular base component having an outer edge, an inner base surface and an outer base surface opposing the inner base surface, the inner base surface provided with a liquid impermeable layer and having a circumferential region of the inner base surface comprising a sealable lacquer coating.

In embodiments, the circumferential region (and thus the sealable lacquer coating provided thereon) may extend from the outer edge towards the centre of the circular base component by a distance of at least about 6 mm, at least about 7 mm, at least about 8 mm, at least about 9 mm, at least about 10 mm, at least about 11 mm, at least about 12 mm, at least about 13 mm, at least about 14 mm, or at least about 15 mm. In certain embodiments, the circumferential region may extend from the outer edge towards the centre of the circular base component by a distance of about 5 to about 20 mm, about 7 to about 15 mm or about 8 to about 12 mm.

The circular base component of this aspect of the invention may comprise a fold line extending circumferentially around the inner base surface within the circumferential region of the inner base surface. In embodiments, the fold line is visible, for example it may be marked or scored.

The outer base surface of the circular base component may or may not comprise a liquid impermeable layer.

The circular base component of this aspect of the invention may comprise any of the features of the circular base component comprised within the container of the invention as disclosed herein.

For example, in embodiments of the invention, the outer base surface may comprise a circumferential region comprising a sealable lacquer coating which optionally is positioned between the outer edge of the circular base component and a fold line. The fold line may be positioned to correspond to the position of the fold line on the inner base surface, i.e. such that when the circular base component is folded about the fold line on the inner base surface, it is also folded about the fold line in the outer base surface.

In embodiments in which the outer base surface comprises a circumferential region comprising a sealable lacquer coating, the weight of the sealable lacquer coating provided in the circumferential region may be greater than the weight of the sealable lacquer coating provided in the circumferential region of the inner base surface.

In embodiments, the circumferential region on the outer base surface may extend from the outer edge towards the centre of the circular base component by a distance of at least about 6 mm, at least about 7 mm, at least about 8 mm, at least about 9 mm, at least about 10 mm, at least about 11 mm, at least about 12 mm, at least about 13 mm, at least about 14 mm, or at least about 15 mm. In certain embodiments, the circumferential region on the outer base surface may extend from the outer edge towards the centre of the circular base component by a distance smaller than the distance by which the circumferential region on the inner base surface extends from the outer edge towards the centre of the circular base component.

In embodiments of the invention, the circular base component of this aspect of the invention may be formed by cutting (e.g. die cutting) the circular base component from a web. Thus, according to a further aspect of the present invention, there is provided a web comprising an inner surface and an outer surface opposing the inner surface, the inner surface comprising a liquid impermeable layer and a plurality of circular regions comprising sealable lacquer coating around a circumferential region of the circular regions, and a region at the centre of the circular regions which is free of sealable lacquer coating.

In embodiments, the sealable lacquer coating may extend from the circumference of the circular regions towards the centre of the circular regions by a distance of at least about 6 mm, at least about 7 mm, at least about 8 mm, at least about 9 mm, at least about 10 mm, at least about 11 mm, at least about 12 mm, at least about 13 mm, at least about 14 mm, or at least about 15 mm. In certain embodiments, the sealable lacquer coating may extend from the circumference of the circular regions towards the centre of the circular regions by a distance of about 5 to about 20 mm, about 7 to about 15 mm or about 8 to about 12 mm.

In some embodiments the outer surface of the web may comprise circular regions positioned on the web to correspond to the position of the circular regions on the inner surface of the web, wherein the circular regions on the outer surface of the web comprise a sealable lacquer coating around a circumference of the circular regions, and a region at the centre of the circular regions on the outer surface of the web which is free of sealable lacquer coating.

In such embodiments, the sealable lacquer coating comprised on the outer surface may extend from the circumference of the circular regions on the outer surface of the web towards the centre of the circular regions by a distance of at least about 6 mm, at least about 7 mm, at least about 8 mm, at least about 9 mm, at least about 10 mm, at least about 11 mm, at least about 12 mm, at least about 13 mm, at least about 14 mm, or at least about 15 mm. In certain embodiments, the sealable lacquer coating may extend from the circumference of the circular regions towards the centre of the circular regions by a distance of about 5 to about 20 mm, about 7 to about 15 mm or about 8 to about 12 mm. In certain embodiments, the sealable lacquer coating comprised on the outer surface may extend from the circumference of the circular regions towards the centre of the circular regions by a distance smaller than the distance by which the sealable lacquer coating on the inner surface of the web extends from the circumference of the circular regions towards the centre of the circular regions.

In embodiments, the circular regions may have a diameter of from about 30 mm to about 100 mm, about 35 mm to about 80 mm, or about 40 mm to about 65 mm.

The circular regions provided on the web of this aspect of the invention may comprise any of the features of the circular base component disclosed herein in connection with other aspects of the invention.

According to a further aspect of the invention, there is provided a method of producing circular base components for containers comprising providing a web as discussed herein and die cutting a plurality of circular regions from the web to provide the circular base components.

In a further embodiment, the tubular wall component may be formed from a quadrilateral wall blank defining four edges. In embodiments, a first edge and second edge are opposing one another, wherein a first edge sealing portion extends partially across the inner wall surface from the first edge and a second edge sealing portion extends partially across the outer wall surface from the second edge. One or both of the first and second edge sealing portions may comprise a sealable lacquer coating. Optionally, the outer wall surface may comprise a portion comprising sealable lacquer coating extending from the first edge. In embodiments, the first and second edges of the quadrilateral wall blank are not parallel.

In embodiments, the first and second edges of the quadrilateral wall blank are equal in length to one another. As those skilled in the art will recognise, the use of quadrilateral wall blanks to produce containers is well known, including those in which notches or other portions are cut out in order to facilitate manufacture of the container (e.g. as is shown in second edge 20 in FIGS. 1 and 2). For the avoidance of doubt, where reference is made herein to the first and second edges of the quadrilateral wall blank being equal in length to one another, the length of the edges is measured not taking into account the effect of such notches or other cut out portions on the length of the edge, i.e. as if no notches or cut out portions were present.

As noted above, in the container of the invention, the tubular wall component comprises an inner wall surface and an outer wall surface opposing the inner wall surface. The inner wall surface comprises a liquid impermeable layer. Further, the tubular component comprises a base sealing portion at one end of the tubular wall component.

The tubular wall component may be formed from a quadrilateral blank. Thus, according to a further aspect of the present invention, there is provided a quadrilateral wall blank comprising an inner wall surface and an outer wall surface opposing the inner wall surface, the inner wall surface comprising a liquid impermeable layer, the quadrilateral wall blank further comprising a first edge and second edge opposing the first edge, wherein the first and second edges are linear, and a third edge and a fourth edge opposing the third edge, each of the third and fourth edges defining an arc, wherein a first edge sealing portion extends partially across the inner wall surface from the first edge and a second edge sealing portion extends partially across the outer wall surface from the second edge, and the first edge sealing portion and/or the second edge sealing portion comprise a sealable lacquer coating, and wherein a base sealing portion extends partially across the inner wall surface from the third edge.

In such embodiments, the base sealing portion may comprise a sealable lacquer coating.

The quadrilateral wall blank may be substantially planar.

The outer wall surface of the quadrilateral blank may or may not comprise a liquid impermeable layer. Additionally or alternatively, the outer wall surface of the quadrilateral blank may comprise a varnish, which may or may not be the same as the sealable lacquer coating.

The base sealing portion (and optionally the sealable lacquer coating) may extend from some or substantially all of the third edge. In embodiments, the base sealing portion (and optionally the sealable lacquer coating) extends from the entirety of the third edge

In embodiments, the first edge sealing portion (and optionally a sealable lacquer coating) may extend from some or substantially all of the first edge. In embodiments, the first edge sealing portion (and optionally the sealable lacquer coating) extends from the entirety of the first edge.

In embodiments, the second edge sealing portion (and optionally a sealable lacquer coating) may extend from some or substantially all of the second edge. In embodiments, the second edge sealing portion (and optionally the sealable lacquer coating) extends from the entirety of the second edge.

The quadrilateral blank of this aspect of the invention may comprise any of the features of the tubular wall component comprised within the container of the invention as disclosed herein, and vice versa.

In some embodiments, a portion of the inner wall surface or the outer wall surface extending partially along that surface from the fourth edge of the quadrilateral blank may comprise an additional layer of liquid impermeable barrier material and/or sealable lacquer. This portion may extend from some or substantially all of the fourth edge. In embodiments, this portion extends from the entirety of the fourth edge. In certain embodiments, this portion may extend along the surface of the quadrilateral blank from the fourth edge by a distance of about 5 mm to about 30 mm, about 7 mm to about 20 mm, or about 10 mm to about 15 mm.

In certain embodiments, the first edge sealing portion contacts the base sealing portion. For example, the sealable lacquer coating may extend continuously from the first edge and the third edge of inner wall surface of the quadrilateral blank. Additionally or alternatively, the portion comprising sealable lacquer coating may extend continuously from the fourth edge, the first edge (e.g. the first edge sealing portion) and/or the third edge (e.g. the base sealing portion) of the inner wall surface of the quadrilateral blank. In some embodiments, the portion comprising sealable lacquer coating may extend continuously from the fourth edge, the first edge (e.g. the wall sealing portion) and the third edge (e.g. the base sealing portion) of the inner wall surface of the quadrilateral blank.

In embodiments of the invention, the outer wall surface of the first edge of the quadrilateral blank or the tubular component of the container may comprise a portion of sealable lacquer coating that extends partially or totally across the outer wall and may extend from some, substantially all, or the entirety of the first edge. Additionally or alternatively, the inner wall surface of the of the second edge of the quadrilateral blank or the tubular component of the container may comprise a portion of sealable lacquer coating that extends partially across the inner wall and may extend from some, substantially all, or the entirety of the second edge.

In certain embodiments, one or more of the second, third or fourth edges of the quadrilateral blank comprise a liquid impermeable layer and/or a sealable lacquer coating.

The first and second edge sealing portions may be overlapped and sealed together to form a wall seam and provide a three dimensional tubular form, such that the sealable lacquer coating is present within the wall seam between the first and second edges.

A further aspect of the present invention provides a method of manufacture of a fibre based packaging container, wherein the method comprises the steps of:
a. providing a quadrilateral blank (optionally the quadrilateral blank as described herein) comprising an inner wall surface and an outer wall surface opposing the inner wall surface, the inner wall surface comprising a liquid impermeable layer, the quadrilateral wall blank further comprising a first edge and second edge opposing the first edge, wherein the first and second edges are linear, and a third edge and a fourth edge opposing the third edge, each of the third and fourth edges defining an arc, wherein a first edge sealing portion extends partially across the inner wall surface from the first edge and a second edge sealing portion extends partially across the outer wall surface from the second edge, and wherein a base sealing portion extends partially across the inner wall surface from the third edge;
b. providing a circular base component (optionally the circular base component as described herein) comprising an outer edge, an inner base surface and an outer base surface opposing the inner base surface, the inner base surface comprising a liquid impermeable layer and a circumferential region comprising a sealable lacquer coating, and a wall sealing portion located within the circumferential region on the inner base surface;
c. flexing the quadrilateral blank to bring the first and second edges into overlapped engagement with one another, and sealing them (optionally ultrasonically) to one another to form a tubular wall component with a wall seam;
d. folding the circular base component at a fold line extending within the circumferential region around the whole of the circular base component to create a circumferentially folded edge comprising the wall sealing portion extending at 80 to 100 degrees from the rest of the circular base component; and
e. sealing (optionally heat sealing) the wall sealing portion and the base sealing portion to one another to create a base seam between the tubular wall component and the circular base component, wherein the sealable lacquer coating is present within the base seam.

In one embodiment, the base sealing portion of the quadrilateral blank comprises sealable lacquer coating.

In embodiments, the base sealing portion of the tubular wall component may be folded around the circumferentially folded edge region, optionally prior to step e. and/or following step d.

In a preferred embodiment, a portion of the circumferential portion comprising sealable lacquer coating extends across the inner base surface of the circular base component beyond the base seam in a direction away from the adjacent tubular wall component. Preferably, the sealable coating extends at least about 2 mm, at least about 4 mm or at least about 6 mm beyond the base seam.

In a further embodiment, one or both of the first and second edge sealing portions comprises sealable lacquer coating such that the sealable lacquer coating extends within the wall seam formed in step c).

In some embodiments, the method may further comprise the step of rolling the fourth edge of the quadrilateral blank or tubular wall component, e.g. to provide a more comfortable rim for the user when drinking from the cup.

In certain embodiments, the method further comprises the step of applying a second liquid impermeable layer to the inner base surface of the base. In such embodiments, the second liquid impermeable layer covers the sealable lacquer coating that extends across the inner base surface, thus providing additional protection against moisture permeation.

The second liquid impermeable layer may comprise the same barrier material as the first liquid impermeable layer applied to the inner base surface of the base.

In alternative embodiments, the second liquid impermeable layer may comprise a different barrier material as the liquid impermeable layer applied to the inner base surface of the base.

The second liquid impermeable layer may comprise any of the liquid impermeable barrier materials and/or have any of the properties of the liquid barrier materials discussed herein.

The skilled artisan will be familiar with techniques for forming rolled rims in containers. Typically, this step is carried out in a rim forming station and as part of the process a lubricant such as paraffin oil is applied to facilitate rim curling/forming. The inventors have advantageously found, however, that by applying the liquid impermeable barrier instead of the lubricant, the liquid impermeable barrier material functions effectively as a lubricant but, once dried, functions as a barrier to provide additional resistance to moisture penetration. Thus, in embodiments of the invention, lubricant (other than the liquid impermeable barrier material) may not be applied during the step of rolling the fourth edge of the quadrilateral blank or the upper edge of the tubular wall component to form a rolled rim. In certain embodiments, liquid impermeable barrier material may be applied to a portion of the inner wall surface or the outer wall surface extending from the fourth edge of the quadrilateral blank or the upper edge of the tubular wall component prior to or during the step of rolling that edge to form a rolled rim. This may be in addition to or instead of the application of a second liquid impermeable layer to the rolled rim.

The present application discloses multiple aspects of the invention, e.g. a container, components of the container and methods of preparing a container. Unless otherwise stated, the disclosure of features in connection with one aspect of the invention is not limited to those features only being provided in connection with that aspect. To the contrary, where a feature of a component is disclosed in connection with one aspect of the invention, it may also be provided in the corresponding component of any other aspect of the invention.

### BRIEF DESCRIPTION OF THE DRAWINGS

FIG. 1 is an illustration of an outer surface of wall blank of a container in accordance with a first embodiment of the present invention;

FIG. 2 is an illustration of an inner surface of the wall blank of FIG. 1;

FIG. 3 is an illustration of an upper surface of a web of base blanks, each for a container in accordance with a first embodiment of the present invention; and

FIG. 4 is an illustration of an assembled container in accordance with a first embodiment of the present invention;

FIG. 5 is a cross-sectional view of the base portion of an embodiment of the container of FIG. 4 with a sealable lacquer coating with a standard tolerance area;

FIG. 6 is a cross-sectional view of the base portion of a further embodiment of the container of FIG. 4 with a sealable lacquer coating with a lower tolerance area; and

FIG. 7 is a cross-sectional view of the base portion of a further embodiment of the container of FIG. 4 with a sealable lacquer coating with a higher tolerance area.

FIG. 8 is an image of a container of the invention following a liquid penetration test.

FIGS. 9A and 9B are images of containers (one of the invention, and one comparative) following a liquid penetration test.

### DETAILED DESCRIPTION OF THE PREFERRED EMBODIMENTS

Embodiments of the present invention will now be described with reference to, but not limited to, the aforementioned figures.

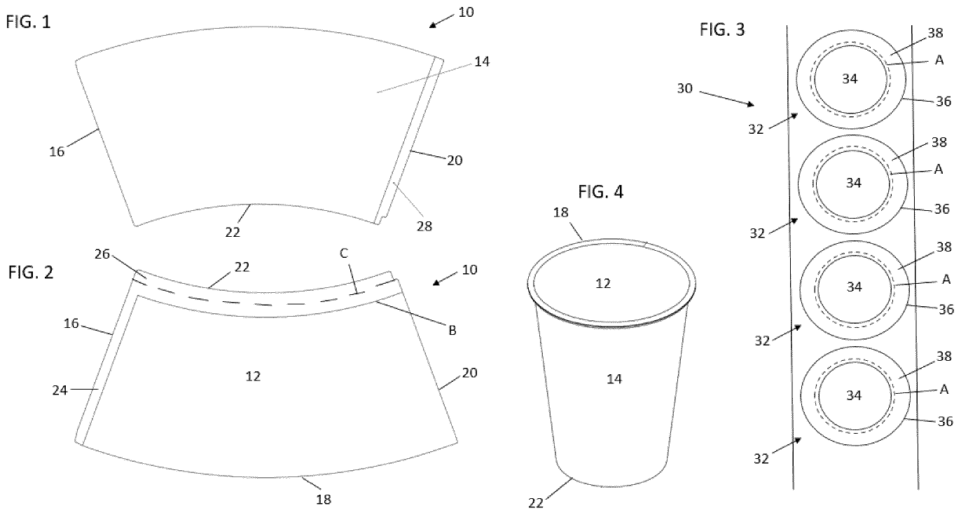

FIGS. 1 and 2 illustrate a quadrilateral wall blank 10 comprising a paperboard substrate. Wall blank 10 has a substantially planar inner surface 12 and a substantially planar outer surface 14. Blank 10 defines four edges i.e., first edge 16, second edge 20, third edge 22 and fourth edge 18. The four edges, 16, 18, 20, 22, extend all the way around inner and outer surfaces 12, 14.

First edge 16 is opposed to second edge 20 and both first and second edges 16, 20, are linear and identical in length. Fourth edge 18 is opposed to third edge 22 and each of the third and fourth edges 22, 18 define arcs that extend parallel to one another. First and second edges 16, 20 are not parallel to one another and extend at such an angle that fourth edge 18 is greater in length than third edge 22.

Inner surface 12 will form the inside of beverage container, once assembled, and outer surface 14 will form the outside of beverage container. Therefore, the paperboard substrate of inner surface 12 is coated with a suitable liquid impermeable coating, in this case a mineral barrier coating. Any suitable liquid impermeable barrier coating that is safe for use with liquids for human consumption may be used either as an alternative to, or in addition to, the barrier coating of the embodiment shown in the figures.

Outer surface 14 of wall blank 10 is not provided with a liquid impermeable barrier coating, as outer surface 14 forms the outer wall of the beverage containing, once assembled and therefore does not require such a barrier coating as outer surface 14 will not come into contact with liquid during use.

A first edge sealing portion 24 is provided on inner surface 12 extending adjacent and from the full length of first edge 16. A corresponding second edge sealing portion 28 is provided on outer surface 14, extending adjacent and from the full length of second edge 20. A base sealing portion 26 is provided on inner surface 12 extending adjacent and from the full length of third edge 22.

The base sealing portion 26 is provided with a thermosealable lacquer coating applied over the barrier coating.

FIG. 3 shows a web 30 of paperboard substrate comprising multiple circular base components 32. Each base component 32 is circular in form and comprises an inner base surface 34 and an outer base surface (not shown) opposing inner base surface 34. Inner base surface 34 is provided with a liquid impermeable coating. Each circular base component 32 defines a circular outer edge 36 extending around the whole of circular base component 32. A circumferential region 38 is provided on base inner surface 34 and extends adjacent to and from the full length of circular outer edge 36. The circumferential region 38 is provided with a thermosealable lacquer coating applied over the liquid impermeable layer. Within the circumferential region 38, the wall sealing portion is positioned between the fold line A and the outer edge 36.

During the assembly process, quadrilateral wall blank 10 is curved so as to bring first and second edges 16, 20 towards one another and to overlap with one another such that first edge sealing portion 24 is brought into engagement with second edge sealing portion 28. Once the first and second sealing portions 24, 28 have been overlapped, ultrasonic energy is applied to seal the first and second edge sealing portions 24, 28 to one another, thereby creating a sealed wall seam which will subsequently extend along the height of the resulting beverage container, or cup. Quadrilateral wall blank 10 now forms a tubular shape and is ready to be assembled with a respective circular base component 32.

During the assembly process, circular base component 32 is punched from the sheet 30 and inserted into a base toll of a cup forming machine (not shown). A fold line A is located within circumferential portion and extends around circular base component 32. The circular base component 32 is then folded at an angle of around 90 degrees along fold line A, such that the thermosealable lacquer coating in the circumferential region extends across and beyond the fold line.

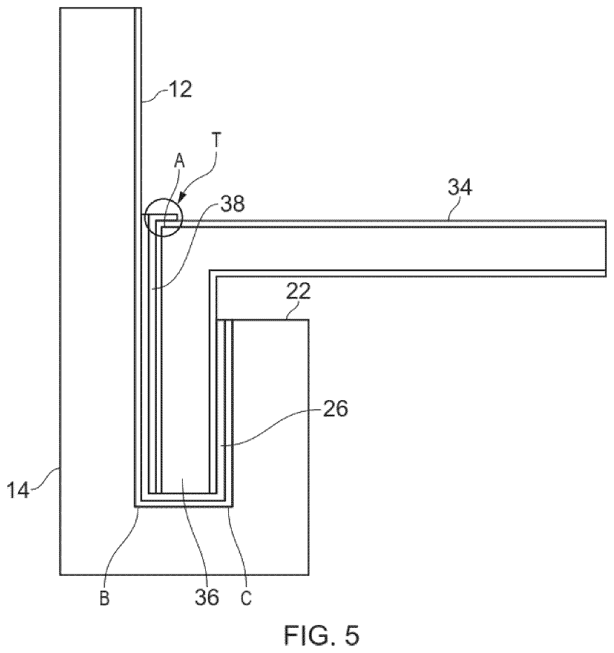

Quadrilateral wall blank 10 is also folded about fold lines B and C to create a U shaped profile (see FIGS. 5 to 7).

The folded portion 40 of circular base component 32 is then positioned within the U shaped profile of quadrilateral wall blank 10 such that the wall sealing portion comprised within the circumferential region 38 between the outer edge 36 and fold line A overlaps with base sealing portion 26 of quadrilateral wall blank 10 when the folded quadrilateral wall blank 10 and folded circular base component 32 are brought into engagement with one another. Pressure and heat are then applied to heat seal base sealing portion 26 and wall sealing portion to one another thereby retaining a portion of the sealable lacquer coating within the resulting heat sealed seam at the base of beverage container (see FIGS. 5 to 7).

Thus, a portion of circumferential region 38, and thus the thermosealable lacquer coating applied thereto will then extend past the fold in base 32, such that a small margin of thermosealable lacquer coating will be present at the interior base surface of the fully assembled beverage container. This positioning of a part of the circumferential region and thus the thermosealable lacquer coating is to provide for position fluctuations during application of the thermosealable lacquer coating to the web 30 prior to cutting out of the circular base components 32. This positioning also ensures that thermosealable lacquer coating will protect the edge of the barrier coating layer that could crack during the folding process, due to the less elastic nature of the liquid impermeable coating layer. This is illustrated in FIG. 5, which shows a standard tolerance area of thermosealable lacquer coating extending across the inner surface 34 of the circular base component of assembled beverage container.

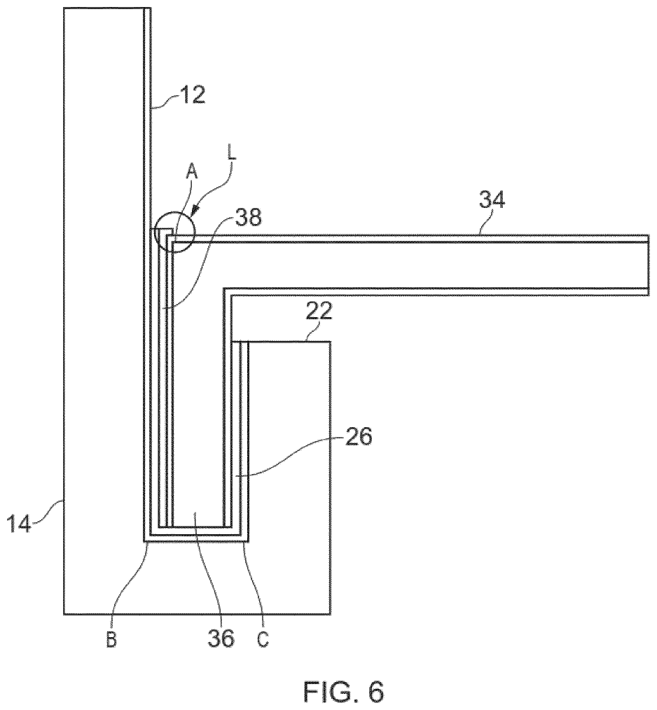

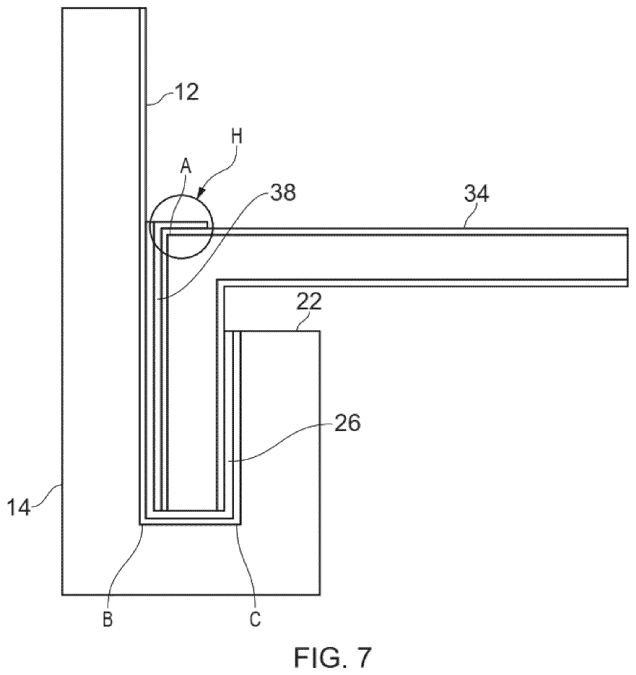

It is to be appreciated that different tolerance areas of sealable lacquer coating may result due to position fluctuations during application of the sealable lacquer coating to the web 30 prior to cutting out of the circular base components 32. FIG. 6 shows a cross-section where there is a low tolerance area of sealable lacquer coating extending across the inner surface 34 of the circular base component of assembled beverage container, and FIG. 7 shows where there is a high tolerance area of sealable lacquer coating extending across the inner surface 34 of the circular base component of assembled beverage container.

Assembled beverage container is shown in FIG. 4 and comprises an interior space defined by a portion of inner surface 12 of tubular component 10 and a portion of circular base component inner surface 34, such that the whole of the exposed interior lining of beverage container is provided with a liquid impermeable coating.

Thus, the sealable lacquer coating prevents cracking of the liquid impermeable layer at the fold line A when the circular base component 32 is folded. Additionally, sealable lacquer coating may also be applied at first and second sealing portions 24, 28. The resulting seal will then contain a sealable lacquer within the seal. As the sealable lacquer is elastic, this will assist with maintaining the integrity of the seal extending along the height of the beverage container, even when flexed on filling with liquid and/or during manipulation by a user.

Thus, the combination of a liquid impermeable layer and sealable lacquer coating contributes to the usability of the beverage container. The liquid impermeable layer provides a liquid barrier to prevent liquid accessing the paperboard substrate. The sealable lacquer coating allows sealing to take place to form seals to retain the three dimensional form of beverage container. However, in addition, as the sealable lacquer coating is also elastic, the seals remain intact and leak proof even on flexing of beverage container for example, when being filled with liquid and/or handled by a user. Thus, the present invention provides a disposable beverage container which is reliable, leak proof and durable during use.

This is a significant advantage over conventional prior art disposable cups in which the heat sealing operation relies on the liquid impermeable barrier coating to form the heat seals at the sealing portions (on application of heat and pressure during the manufacturing process). It also advantageously permits the production of disposable cups which are free of materials which render the cups non-recyclable such as polyethylene. In the present application, the presence of the elastic sealable lacquer at the seal and the fold in the circular base component of the cup will prevent the seal from failing and the cup from leaking.

It is to be appreciated that the container of the present invention need not be limited to a beverage container such as a cup, but is equally applicable to any other food or liquid packaging, such as but not limited to, a bowl, jug, paintpot, paper bucket or any other similarly manufactured liquid impermeable disposable container.

The invention will now be illustrated by the examples which follow.

### Example 1—Testing of Liquid Absorbance Into Container Base

Paper cups were manufactured as discussed herein. The wall and base of the cup were produced from clay-coated cup-stock of standard weight. A mineral coating comprising silica was applied to the inner base surface of the base and the inner wall surface of the quadrilateral blank as an emulsion, at a coating weight of ~5 g/m² and permitted to dry. For a first group of cups (comparators), a sealable lacquer was applied at a weight of ~10 g/m² only to a circumferential region of the inner base surface extending from the fold line to the outer edge. For a second group of cups (inventive), the sealable lacquer (same coating weight) was applied at a circumferential region extending from the outer edge of the container base beyond the fold line by a distance from the fold line across the inner base surface of ~8 mm.

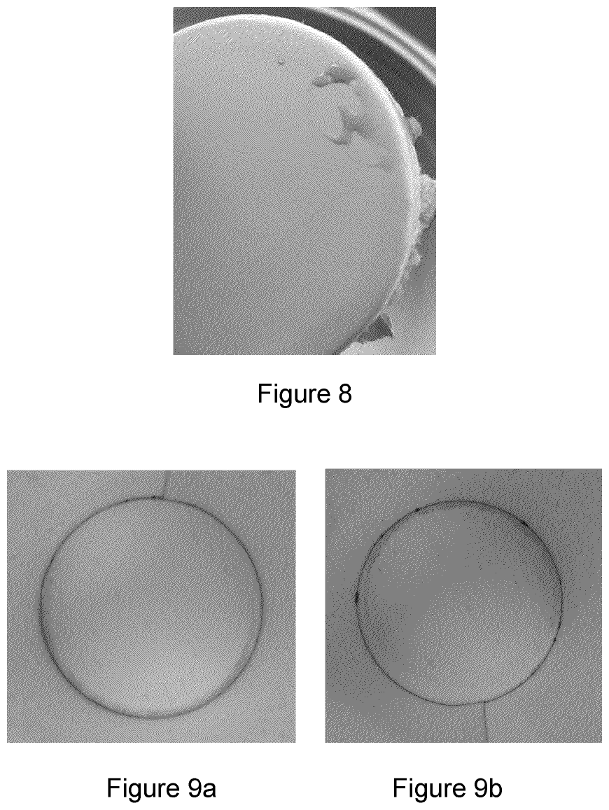

Coffee at a temperature of ~95° C. was filled into the cups and left for 60 minutes. Following that time, the container base of the first group of cups had absorbed an unacceptable volume of fluid, whereas, as shown in FIG. 8, the container base of the second group of cups was resistant to moisture ingress.

### Example 2—Impact on Sealable Lacquer Extending Inwardly Beyond Fold Line

Two sets of 12 ounce paper cups were manufactured as discussed herein. Both sets comprised tubular wall components and circular base components comprising a mineral coating comprising silica. The circular base component was formed of stock paper having a weight of 265 g/m².

In the first set of cups (inventive), the circumferential region of the upper surface of the circular base component comprised sealable lacquer and extended from the outer edge of the circular base component towards the centre of the component, passing over the fold line by 10 mm. In the second set of cups (comparative) the circumferential region of the upper surface of the circular base component comprised sealable lacquer and extended from the outer edge of the circular base component to the fold line, but did not cross the fold line, as per the configuration disclosed in EP4043362.

Both Sets of cups were filled with coffee at a temperature of 93° C. and the filled cups were then left for one hour.

After an hour, the cups were emptied and their interiors inspected. Images of the interior of an example of a cup from the first set (inventive) is provided as FIG. 9A. As can be seen, very little bleeding of coffee into the edge of the cup base is visible, confirming that the mineral barrier functioned effectively to prevent the ingress of moisture into the cup base. In contrast, as can be seen from FIG. 9B (an image of the interior of a cup from the second set (comparative)) the absence of a portion of sealable lacquer extending inwardly towards the centre of the upper surface of the base from the fold line resulted in coffee bleeding extensively into the edge of the cup base. Additionally, the base of the comparative cups was softer and weaker to touch than the corresponding inventive cups.

1. A fibre based packaging container for holding liquids, the packaging container comprising:
a. a tubular wall component comprising an inner wall surface and an outer wall surface opposing the inner wall surface, the inner wall surface comprising a liquid impermeable layer and a base sealing portion at one end of the tubular wall component; and
b. a circular base component comprising an outer edge, an inner base surface and an outer base surface opposing the inner base surface, the inner base surface comprising a liquid impermeable layer and further comprising: a circumferential region extending from the outer edge comprising a sealable lacquer coating, a fold line extending circumferentially around the inner base surface within the circumferential region of the inner base surface, and a wall sealing portion located on the inner base surface between the outer edge of the base and the fold line, wherein the circular base component is folded at 80 to 100 degrees about the fold line to form a folded portion comprising the wall sealing portion,
wherein the wall sealing portion and at least a portion of the base sealing portion are sealed to one another to form a base seam and provide a three dimensional container form, such that the sealable lacquer coating is present within the base seam.

2. (canceled)

3. The fibre based packaging container as claimed in claim 1, wherein the liquid impermeable layer comprises an inorganic mineral and the sealable lacquer coating is provided on top of the inorganic mineral layer.

4. The fibre based packaging container as claimed in claim 1, wherein a portion of the circumferential region comprising a sealable lacquer coating extends across the inner base surface beyond the base seam in a direction away from the tubular wall component.

5. The fibre based packaging container as claimed in claim 4, wherein the sealable lacquer coating extends across the inner base surface by at least 2 mm beyond the base seam.

6. (canceled)

7. (canceled)

8. The fibre based packaging container as claimed in claim 1, wherein the liquid impermeable layer comprised on the circular base component and/or the tubular wall component has a modulus of elasticity of about 1 GPa or greater.

9. The fibre based packaging container as claimed in claim 8, wherein the sealable lacquer coating comprised on the circumferential region of the inner base surface has a modulus of elasticity which is lower than the modulus of elasticity of the liquid impermeable layer provided on the inner base surface.

10. (canceled)

11. (canceled)

12. The fibre based packaging container as claimed in claim 1, wherein the modulus of elasticity of the sealable lacquer coating comprised on the inner base surface is higher than the modulus of elasticity of the liquid impermeable layer provided on the inner base surface.

13. The fibre based packaging container as claimed in claim 1, wherein the outer base surface of the circular base component comprises a circumferential region extending from the outer edge comprising a sealable lacquer coating.

14. A circular base component having an outer edge, an inner base surface and an outer base surface opposing the inner base surface, the inner base surface provided with a liquid impermeable layer and having a circumferential region of the inner base surface extending from the outer edge comprising a sealable lacquer coating.

15. The circular base component of claim 14, wherein the outer base surface has a circumferential region extending from the outer edge comprising a sealable lacquer coating.

16. (canceled)

17. (canceled)

18. (canceled)

19. (canceled)

20. The fibre based packaging container of claim 1, wherein the liquid impermeable layer comprised on the inner base surface does not comprise a metallic film.

21. The fibre based packaging container of claim 1, wherein the liquid impermeable layer comprised on the inner wall surface does not comprise a metallic film.

22. The fibre based packaging container of claim 1, wherein the tubular wall component is formed from a quadrilateral wall blank, wherein the quadrilateral wall blank comprises an inner wall surface and an outer wall surface opposing the inner wall surface, the inner wall surface comprising a liquid impermeable layer, the quadrilateral wall blank further comprising a first edge and second edge opposing the first edge, wherein the first and second edges are linear, and a third edge and a fourth edge opposing the third edge, each of the third and fourth edges defining an arc, wherein:
a first edge sealing portion extends partially across the inner wall surface from the first edge and a second edge sealing portion extends partially across the outer wall surface from the second edge, and the first edge sealing portion and/or the second edge sealing portion comprise a sealable lacquer coating; and
a base sealing portion extends partially across the inner wall surface from the third edge, and
wherein the first and second edge sealing portions are overlapped and sealed together to form a wall seam and provide a three dimensional tubular form, such that the sealable lacquer coating is present within the wall seam between the first and second edges.

23. The fibre based packaging container of claim 22, wherein the outer wall surface of the tubular component adjacent to the wall seam comprises a sealable lacquer coating.

24. A method of manufacture of a fibre based packaging container, wherein the method comprises the steps of:
a. providing a quadrilateral blank comprising an inner wall surface and an outer wall surface opposing the inner wall surface, the inner wall surface comprising a liquid impermeable layer, the quadrilateral blank further comprising a first edge and second edge opposing the first edge, wherein the first and second edges are linear, and a third edge and a fourth edge opposing the third edge, each of the third and fourth edges defining an arc, wherein a first edge sealing portion extends partially across the inner wall surface from the first edge and a second edge sealing portion extends partially across the outer wall surface from the second edge; and wherein a base sealing portion extends partially across the inner wall surface from the third edge;
b. providing a circular base component comprising an outer edge, an inner base surface and an outer base surface opposing the inner base surface, the inner base surface comprising a liquid impermeable layer and a circumferential region extending from the outer edge comprising a sealable lacquer coating, and a wall sealing portion located within the circumferential region on the inner base surface;
c. flexing the quadrilateral blank to bring the first and second edges into overlapped engagement with one another, and sealing them to one another to form a tubular wall component with a wall seam;
d. folding the circular base component at a fold line extending within the circumferential region around the whole of the circular base component to create a circumferentially folded edge comprising the wall sealing portion extending at 80 to 100 degrees from the rest of the circular base component; and
e. sealing the wall sealing portion and the base sealing portion to one another to create a base seam between the tubular wall component and the circular base component, wherein the sealable lacquer coating is present within the base seam.

25. The method according to claim 24, wherein a portion of the circumferential region comprising the sealable lacquer coating extends across the inner base surface beyond the base seam in a direction away from the adjacent tubular wall component.

26. The method according to claim 25, wherein the sealable lacquer coating extends at least 2 mm beyond the base seam.

27. The method as claimed in claim 24, wherein one or both of the first and second edge sealing portions comprise a sealable lacquer coating such that the sealable lacquer coating is present within the wall seam formed in step c).

28. ) The method as claimed in claim 24, wherein the quadrilateral wall blank has at least one of the first edge sealing portion, the second edge sealing portion, or the base sealing portion comprising a sealable lacquer coating.

29. (canceled)

30. A container obtainable from the process of claim 24
